(19) United States
(12) Patent Application Publication
(10) Pub. No.: US 2017/0329593 A1
(43) Pub. Date: Nov. 16, 2017

(54) INPLACE RETURN TO FACTORY INSTALL (iRTFI)

(71) Applicant: NETAPP, INC., SUNNYVALE, CA (US)

(72) Inventor: Marshall McMullen, Boulder, CO (US)

(21) Appl. No.: 15/156,026

(22) Filed: May 16, 2016

(51) Int. Cl. G06F 9/445; G06F 11/14

(52) U.S. Cl. CPC G06F 8/63; G06F 11/1448; G06F 8/65; G06F 2201/84

(57) ABSTRACT

A server node initially running an original operating system fetches an installation image of an operating system comprising a new root file system for the server node. The server node mounts the installation image into a temporary file storage. The server node changes a root file system of the server node to the new root file system and maintain the root file system as an old root file system. The server node installs new firmware for hardware components of the server node. The server node installs the operating system. The installation of the operating system includes a mount of a root drive at a directory for the installation. The installation of the operating system also includes an extraction of the new root file system into the directory. The server node boots to the operating system with a new kernel replacing the original operating system.

### BACKGROUND

The following description is provided to assist the understanding of the reader. None of the information provided is admitted to be prior art.

A unit of data, such as a file or object, includes one or more storage units (e.g., blocks), and can be stored and retrieved from a storage medium. For example, disk drives in storage systems can be divided into logical blocks that are addressed using logical block addresses (LBAs). The disk drives use spinning disks where a read/write head is used to read/write data to/from the drive. It is desirable to store an entire file in a contiguous range of addresses on the spinning disk. For example, the file may be divided into blocks or extents of a fixed size. Each block of the file may be stored in a contiguous section of the spinning disk. The file is then accessed using an offset and length of the file. Other types of storage systems may also be used to store files or objects.

Storage mediums on which files and/or objects are stored may need to be changed to address changes in the files and/or objects that are stored. For example, if a user needs more storage space for files and/or objects, the storage medium's hardware may be expanded to include more memory for the storing of the additional or larger files and/or objects. Storage mediums may also be controlled by software that is subject to updates to keep the storage system running properly.

### BRIEF DESCRIPTION OF THE DRAWINGS

The foregoing and other features of the present disclosure will become more fully apparent from the following description and appended claims, taken in conjunction with the accompanying drawings.

FIG. 1 depicts a simplified system for a storage system in accordance with an illustrative implementation.

FIGS. 2A and 2B shows a flow diagram of an inplace return to factory install (iRTFI) in accordance with an illustrative implementation.

FIG. 3 shows a flow diagram of a failure scenario prior to backup in accordance with an illustrative implementation.

FIG. 4 shows a flow diagram of a failure scenario after backup in accordance with an illustrative implementation.

FIG. 5 shows a flow diagram of an alternate embodiment of inplace return to factory install (iRTFI) in accordance with an illustrative implementation.

FIG. 6 is a block diagram of a computer system in accordance with an illustrative implementation.

### OVERVIEW

In general, one aspect of the subject matter described in this specification can be embodied in a system that includes a server node comprising one or more processors configured to fetch an installation image of an operating system comprising a new root file system for the server node. The server node initially is running an original operating system. The one or more processors are also configured to mount the installation image into a temporary file storage. The one or more processors are also configured to change a root file system of the server node to the new root file system and maintain the root file system as an old root file system. The one or more processors are also configured to install new firmware for hardware components of the server node. The one or more processors are also configured to install the operating system. The installation of the operating system includes a mount of a root drive at a directory for the installation. The installation of the operating system also includes an extraction of the new root file system into the directory. The one or more processors are also configured to boot to the operating system with a new kernel replacing the original operating system.

Another aspect of the subject matter described in this specification can be embodied in methods of installing an operating system on a server node including fetching an installation image of an operating system comprising a new root file system for the server node. The server node initially is running an original operating system. The method further includes mounting the installation image into a temporary file storage. The method further includes changing a root file system of the server node to the new root file system and maintaining the root file system as an old root file system. The method further includes installing new firmware for hardware components of the server node. The method further includes installing the operating system. The installation of the operating system includes mounting a root drive at a directory for the installation and extracting the new root file system into the directory. The method further includes booting to the operating system with a new kernel replacing the original operating system.

Another aspect of the subject matter described in this specification can be embodied in a non-transitory computer-readable medium having instructions stored thereon, that when executed by a computing device cause the computing device to perform operations including fetching an installation image of an operating system comprising a new root file system for a server node. The server node initially is running an original operating system. The operations further include mounting the installation image into a temporary file storage. The operations further include changing a root file system of the server node to the new root file system and maintaining the root file system as an old root file system. The operations further include installing new firmware for hardware components of the server node. The operations further include installing the operating system. Installation of the operating system includes mounting a root drive at a directory for the installation and extracting the new root file system into the directory. The operations further include booting to the operating system with a new kernel replacing the original operating system.

The foregoing summary is illustrative only and is not intended to be in any way limiting. In addition to the illustrative aspects, implementations, and features described above, further aspects, implementations, and features will become apparent by reference to the following drawings and the detailed description.

### DETAILED DESCRIPTION

Described herein are techniques for an inplace return to factory install, or iRTFI. The iRTFI methods and systems disclosed herein allow for installing software onto server nodes that are used for storage and other purposes. A cluster server may include multiple server nodes. The server nodes may have software located on the nodes updated over time. Server nodes may be added to the cluster server, and the additional server nodes may be installed with the same software that is located on the preexisting nodes. In some cases, such an install may represent a downgrade of software of one node in order to match the other nodes on a cluster. iRTFI specifically allows such installations (including downgrades and upgrades) to server nodes to occur inplace over a running operating system such that no reboot of any the server nodes are needed. Such methods and systems reduce time for software installations, reduce downtime of the server node for an install, and provides transactional consistency of software installations. When an install is transactionally consistent, the install either succeeds or fails and the result of the install will either be the original data or the new data, respectively. The systems and methods disclosed herein also have the advantage of atomicity, where from an external observer iRTFI is a single indivisible process. Although the iRTFI includes discrete steps, an observer may not be able to see a storage node during such steps because the process stops running processes on the storage node. This can effectively cut off communication than an observer could otherwise have with the storage node. Advantageously, this install/upgrade/downgrade process can prevent other storage nodes from seeing the storage node in indeterminate states (e.g., failure, recovery) during an install/upgrade/downgrade process, which may be undesirable due to system-wide programs, characteristics, interactions, etc. Thus, from an observer such as another storage node, the install/upgrade/downgrade happens all during an apparently single step while the processes on the storage node are stopped. As disclosed herein, once the processes on the storage node are running again, the storage node has either completed an install/upgrade/downgrade, or has encountered an error but automatically reverted to an original state. In the following description, for purposes of explanation, numerous examples and specific details are set forth in order to provide a thorough understanding of various implementations. Particular implementations as defined by the claims may include some or all of the features in these examples alone or in combination with other features described below, and may further include modifications and equivalents of the features and concepts described herein.

Storage System

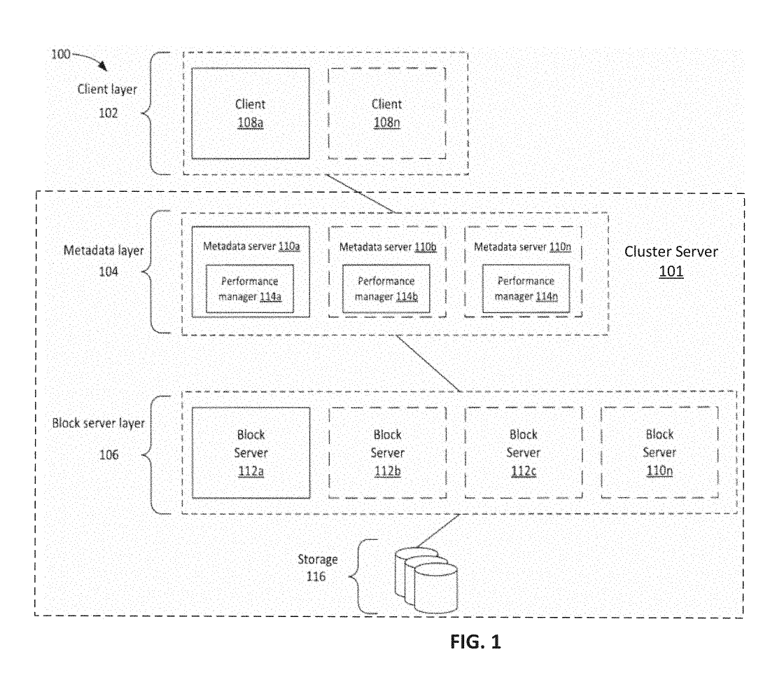

FIG. 1 depicts a storage system 100 in accordance with an illustrative implementation. The system 100 shows just one example system on which iRTFI systems and methods might be executed. Other storage systems which utilize iRTFI are contemplated. The system 100 includes a client layer 102 and a cluster server 101 with a metadata layer 104, a block server layer 106, and storage 116.

In general, the client layer 102 includes one or more clients 108a-108n. The clients 108 include client processes that may exist on one or more physical machines. When the term “client” is used in the disclosure, the action being performed may be performed by a client process. A client process is responsible for storing, retrieving, and deleting data in system 100. A client process may address pieces of data depending on the nature of the storage system and the format of the data stored. For example, the client process may reference data using a client address. The client address may take different forms. For example, in a storage system that uses file storage, client 108 may reference a particular volume or partition, and a file name. With object storage, the client address may be a unique object name. For block storage, the client address may be a volume or partition, and a block address. Clients 108 communicate with metadata layer 104 using different protocols, such as small computer system interface (SCSI), Internet small computer system interface (ISCSI), fibre channel (FC), common Internet file system (CIFS), network file system (NFS), hypertext transfer protocol (HTTP), hypertext transfer protocol secure (HTTPS), web-based distributed authoring and versioning (WebDAV), or a custom protocol.

Metadata layer 104 includes one or more metadata servers 110a-110n. Performance managers 114 may be located on metadata servers 110a-110n. Block server layer 106 includes one or more block servers 112a-112n. Block servers 112a-112n are coupled to storage 116, which stores volume data for clients 108. Each client 108 may be associated with a volume on one more of the metadata servers 110a-110n. In one implementation, only one client 108 accesses data in a volume; however, multiple clients 108 may access data in a single volume.

Storage 116 can include multiple solid state drives (SSDs). In one implementation, storage 116 can be a cluster of individual drives or nodes coupled together via a network. When the term “cluster” is used, it will be recognized that cluster may represent a storage system that includes multiple disks or drives that may or may not be networked together. Further, as used herein, a “cluster server” is used to refer to a cluster of individual storage drives that are associated with the block server layer 106 and the metadata layer 104. For example, a first cluster server 101 is depicted in the system 100 as including the metadata servers 110a-110n, the block servers 112a-112n, and the storage 116. In one implementation, storage 116 uses solid state memory to store persistent data. SSDs use microchips that store data in non-volatile memory chips and contain no moving parts. One consequence of this is that SSDs allow random access to data in different drives in an optimized manner as compared to drives with spinning disks. Read or write requests to non-sequential portions of SSDs can be performed in a comparable amount of time as compared to sequential read or write requests. In contrast, if spinning disks were used, random read/writes would not be efficient since inserting a read/write head at various random locations to read data results in slower data access than if the data is read from sequential locations. Accordingly, using electromechanical disk storage can require that a client's volume of data be concentrated in a small relatively sequential portion of the cluster to avoid slower data access to non-sequential data. Using SSDs removes this limitation.

The cluster server 101 may be made up of various server nodes. Server nodes may include any of the metadata layer 104, the block server layer 106, and/or the storage 116. The server nodes can be added or taken away from the cluster server 101 to increase or decrease capacity, functionality, etc. of the cluster server 101. Server nodes of the cluster server 101 are controlled by software stored thereon. For example, the server nodes of the cluster server 101 may use an operating system such as Linux. Server nodes may be updated with new software periodically. Server nodes may also be added to the cluster server 101 and may be subject to an upgrade or downgrade in software to match the operating system controlling other server nodes already existing in the cluster server 101. Such updates, downgrades, upgrades, installations, etc. my be effected using iRTFI as disclosed herein at length below.

In various implementations, non-sequentially storing data in storage 116 is based upon breaking data up into one more storage units, e.g., data blocks. A data block, therefore, is the raw data for a volume and may be the smallest addressable unit of data. The metadata layer 104 or the client layer 102 can break data into data blocks. The data blocks can then be stored on multiple block servers 112. Data blocks can be of a fixed size, can be initially a fixed size but compressed, or can be of a variable size. Data blocks can also be segmented based on the contextual content of the block. For example, data of a particular type may have a larger data block size compared to other types of data. Maintaining segmentation of the blocks on a write (and corresponding re-assembly on a read) may occur in client layer 102 and/or metadata layer 104. Also, compression may occur in client layer 102, metadata layer 104, and/or block server layer 106.

In addition to storing data non-sequentially, data blocks can be stored to achieve substantially even distribution across the storage system. In various examples, even distribution can be based upon a unique block identifier. A block identifier can be an identifier that is determined based on the content of the data block, such as by a hash of the content. The block identifier is unique to that block of data. For example, blocks with the same content have the same block identifier, but blocks with different content have different block identifiers. To achieve even distribution, the values of possible unique identifiers can have a uniform distribution. Accordingly, storing data blocks based upon the unique identifier, or a portion of the unique identifier, results in the data being stored substantially evenly across drives in the cluster.

Because client data, e.g., a volume associated with the client, is spread evenly across all of the drives in the cluster, every drive in the cluster is involved in the read and write paths of each volume. This configuration balances the data and load across all of the drives. This arrangement also removes hot spots within the cluster, which can occur when client's data is stored sequentially on any volume.

In addition, having data spread evenly across drives in the cluster allows a consistent total aggregate performance of a cluster to be defined and achieved. This aggregation can be achieved, since data for each client is spread evenly through the drives. Accordingly, a client's I/O will involve all the drives in the cluster. Since, all clients have their data spread substantially evenly through all the drives in the storage system, a performance of the system can be described in aggregate as a single number, e.g., the sum of performance of all the drives in the storage system.

Block servers 112 maintain a mapping between a block identifier and the location of the data block in a storage medium 116 of block server 112. A volume maintained at the metadata layer 104 includes these unique and uniformly random identifiers, and so a volume's data is also evenly distributed throughout the storage 116 of the cluster server 101.

Metadata layer 104 stores metadata that maps between client layer 102 and block server layer 106. For example, metadata servers 110 map between the client addressing used by clients 108 (e.g., file names, object names, block numbers, etc.) and block layer addressing (e.g., block identifiers) used in block server layer 106. Clients 108 may perform access based on client addresses. However, as described above, block servers 112 store data based upon identifiers and do not store data based on client addresses. Accordingly, a client can access data using a client address which is eventually translated into the corresponding unique identifiers that reference the client's data in storage 116.

Although the parts of system 100 are shown as being logically separate, entities may be combined in different fashions. For example, the functions of any of the layers may be combined into a single process or single machine (e.g., a computing device) and multiple functions or all functions may exist on one machine or across multiple machines. Also, when operating across multiple machines, the machines may communicate using a network interface, such as a local area network (LAN) or a wide area network (WAN). Entities in system 100 may be virtualized entities. For example, multiple virtual block servers 112 may be included on a machine. Entities may also be included in a cluster, where computing resources of the cluster are virtualized such that the computing resources appear as a single entity. All or some aspects of the system 100 may also be included in one or more server nodes as disclosed herein.

Inplace Return to Factory Install (iRTFI)

A return to factory install (RTFI) is a process for installing software, for example, onto server nodes. An RTFI can be a bootable ISO which contains a payload and a set of bash scripts which unpack and install the payload and then reboot the machine into the newly installed operating system. In contrast, an inplace return to factory install (iRTFI) does not use booting into an ISO in order to perform the RTFI operation. Instead, the iRTFI performs the installation inplace right over the running operating system with no reboots.

The systems and methods disclosed herein also use various functions or commands, such as functions or commands that are associated with an operating system. For example, in some embodiments, Linux may be used along with hardware components and Linux associated functions or commands as disclosed herein. For example, the Linux command kexec is a tool used in some embodiments of iRTFI in order to implement software upgrades/downgrades/installs without performing any reboots. The kexec command is a mechanism of the Linux kernel that allows live booting of a new kernel over the currently running one. In other words, kexec skips the bootloader stage and hardware initialization phase performed by the system firmware (e.g., BIOS or UEFI), and directly loads a new kernel into main memory and starts executing it immediately. Use of the kexec command can help avoid the long times associated with a full reboot, and can help systems to meet high availability requirements by minimizing downtime. Another command used herein in some embodiments is chroot. Chroot may be used during RTFI and/or iRTFI to create a new operating system being installed. In other words, a drive can be mounted in a particular directory (i.e., /mnt/chroot) and the payload is unpacked into that directory. Then the system can chroot into that directory in order to install and interact with that installation as if the system had booted into it natively. Another command used herein in some embodiments is pivot_root. Pivot root can be used to swap a current root file system with another. The command allows the system to stop using the drive the current OS is running on so that the system can unmount the drive and reformat the drive as needed for the new installation.

Using pivot_root in order to install over a running system without having to reboot into a standalone bootable ISO offers significant advantages. Accordingly, a live install over a running system without booting into some sort of special install CD/image can be accomplished. Furthermore, using kexec, init kernel parameter, and implicit error traps to achieve automatic rollback on failure as disclosed herein offers many advantages. As disclosed herein, the system uses kexec_load before going into a section of the install process to load the existing kernel along with init kernel parameter to run the rollback process, such as a rollback script, to rollback from an installation failure. The end result is that using kexec, init kernel parameter, and implicit error traps together ensures that any unhandled error gets called and triggers a rollback from the error case.

iRTFI goes through a series of state transitions in order to accomplish its task. The state transitions are discussed at length below. iRTFI is transactionally consistent, and therefore reaches one of the following states: (1) FinishSuccess: iRTFI is completed successfully without errors; (2) FinishFailure: iRTFI completed unsuccessfully and was forced to rollback to the earlier install. The FinishFailure case protects against a partial/incomplete install or update.

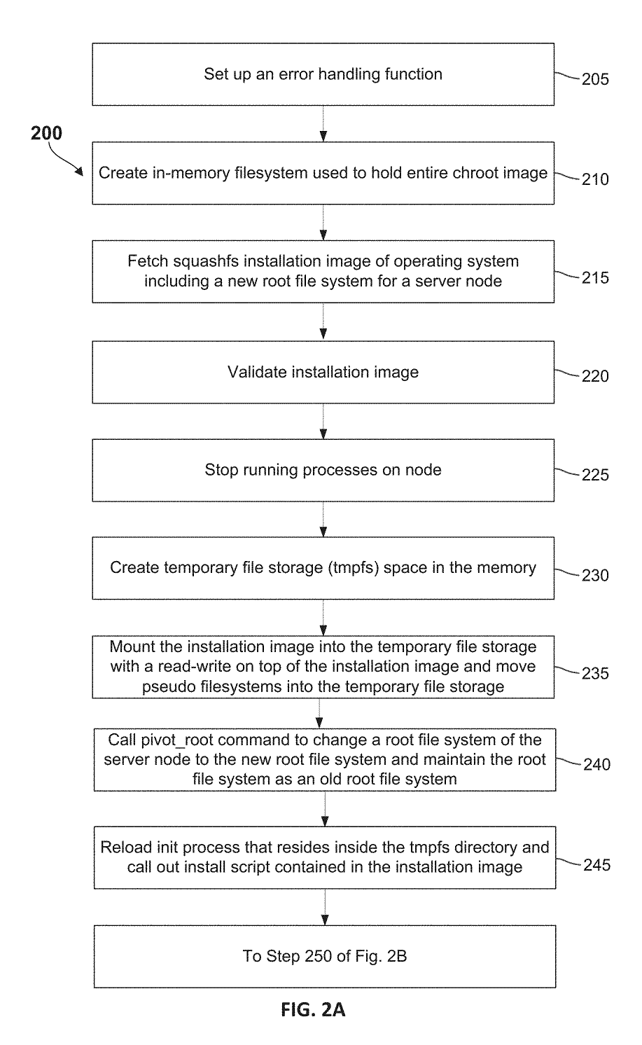

First, a successful iRTFI is disclosed below, along with each state of the iRTFI. The successful iRTFI is one with no errors encountered. If an error were encountered, the system would transition to an abort state and proceed with a rollback to the earlier install (FinishFailure as described above. The successful iRTFI will be discussed with respect to FIG. 2A and 2B.

FIGS. 2A and 2B shows a flow diagram 200 of an inplace return to factory install (iRTFI) in accordance with an illustrative implementation. In alternative embodiments, fewer, additional, and/or different steps may be performed. Also, the use of a flow diagram is not meant to be limiting with respect to the order of steps performed. Further, the system may implement multiple instances of any of the methods disclosed herein, and may implement such methods in parallel.

Prepare State. During a prepare state, iRTFI performs all the necessary steps to prepare for inplace RTFI. In the prepare state, the system sets up an error handling code/function at an operation 205. The function of the error handling code is discussed at greater length below with respect to failure paths. The error handling code detects errors and calls a die function in order handle the error properly. Further during the prepare state, at an operation 210, the system creates an in-memory filesystem that can be used to hold an entire chroot image of an Operating System (OS). At this point the system parses all the options that will be used to control the system's behavior. In other words, the system determines the parameters of the specific processes for the install/upgrade/downgrade. In this way, the iRTFI process can have various options specified dynamically at runtime. Such options may be specified by default settings, via kernel parameters, environment variables, or via explicit options given on a command-line. In one illustrative embodiment, the system may also check for options in a specific order so that options specified in certain ways may override or have priority over options specified in different ways. As just one possible example, the system may first check default settings, then kernel options that may override default settings, then environment variables may override default settings and kernel options, and then explicit options are checked last and may override any of the options/settings. In this way, different aspects of the iRTFI may be controlled. As examples, the options or different settings may include disabling secure erase, changing the bond modes, changing what root drive to install to, and/or programmatically gathering logs and uploading them at the end of the install process. Another one of these options may be specifying a URL used to retrieve an image of the operating system to be installed from. Another option may be an indicator to the system of whether an RTFI or iRTFI install has been specified. Other options may include what type of action is taken during an error when an error function such as die is called. For example, a default may be to invoke the error states disclosed herein with respect to rebooting and calling the kexec_exec command during certain error states. In other examples, an iRTFI option may be set to use a full reboot or may be set to use a bash shell for live debugging of an install failure. Another option may be whether to back up the existing installation (e.g., to the /var/log as disclosed herein) before performing the iRTFI. Such an option saves time for the install. Another option may be whether to preserve various data across an iRTFI, such as a cluster configuration file, contents of data directories, hostnames, network configurations, whitespace separated list of paths, etc. The system therefore proceeds with retrieving an image, such as a filesystem.squashfs image, that will be used to do the install/upgrade/downgrade/etc. In other words, at an operation 215, a processor(s) of the server node fetches an installation image of an operating system comprising a new root file system for the server node. Once the image has been fetched, the system validates, at an operation 220, the installation image using various digest validation metadata. For example, such validation methods may include including MD5, SHA1, SHA256, and PGP.

PreparePivotRoot State. During a PreparePivotRoot state the system frees up the root drive (e.g. /dev/sda2) so that the drive can be securely erased and/or partitioned. In an example server node, the system may have multiple partitions in its memory (e.g., /dev/sda1, /dev/sda2, /dev/sda3), which often correspond (before an iRTFI is initiated) to a boot loader, root filesystem, and a /var/log, respectively. Before the root drive is be freed up, the system stops all running processes at an operation 225. The system then creates temporary file storage (tmpfs) space in memory at an operation 230. At an operation 235, the installation image (filesystem.squashfs) of the operating system is then mounted into the tmpfs space along with a an overlayfs on top of it (because squashfs images may be mounted read only). A squashfs image can be mounted directly without performing extraction of its contents. However, if the squashfs image is mounted read only, the system may not be able to create a temporary file, modify a part of the image (e.g., /etc/fstab), such an action may fail because the image is not writable. As a result, the overlayfs may be used to create an empty directory (e.g., in the tmpfs memory) and mount that on top of the squashfs image. The final mount point of the squashfs image may then be used as if it were readable/writable, even though the underlying squashfs image may be read-only). In this way, the system can, for example, read instructions for the install/downgrade/upgrade from the installation image itself. Further in the operation 235, the system also moves all pseudo filesystems (e.g. /dev, /proc, /run, and /sys) into the tmpfs space. At an operation 240, the system calls pivot_root command to change the root file system to the tmpfs space that has been created in memory while still holding onto an old root file system directory inside /mnt/oldroot. In other words, the system changes a root file system of the server to the new root file system and maintains the root file system as an old root file system. At an operation 245, the system also reloads the init process that resides inside the tmpfs directory to initialize services that allow the operating system and other processes to run. The system also calls out to an install script which is contained within the filesystem.squashfs image that was downloaded/fetched and mounted into tmpfs.

Start State. After the pivot_root to the new install image/file system, code for the install resides in the new image rather than in the old image/file system. At an operation 250, in the start state and based on the install script, a kexec_load command is called to load the current running kernel into kexec memory after the installation image has been mounted into the temporary file storage. The server node is configured to run the install script from the installation image such that the install script installs new firmware, installs the operating system, and boots to the operating system with a new kernel, all as discussed below. If for any reason an error handler function is called a die command is also called. The die command will call a kexec_exec command to invoke an instant restart of the kernel and the operating system. This instant restart can occur because at the operation 250 the kexec_load command was previously called to load the currently running kernel into the kexec memory. As a result, when the kexec_exec command is invoked, the system will restart to the currently running kernel. This is an efficient way to handle errors before any changes are made to the previously installed (old) file system. How errors are handled is discussed in greater length below. Also in the start state, system may start an HTTP server for remote monitoring of the install status/progress. The system can also set the system time and sync it to a hardware clock if possible.

DriveUnlock State. At an operation 255, during this state, the system unlocks some or all of the drives in the server node. This refers to a secure unlock command such as ATA_SECURITY_UNLOCK. This operation allows the system to unlock a drive which may have been previously locked due to encryption or otherwise. For inplace RTFI the drives may not be locked because a security lock may only be in place when a server node loses power. Accordingly, this step may be omitted.

UpgradeFirmware State. During this state the system upgrades (or downgrades) the firmware of various hardware components in the system at an operation 260. In other words, the system installs new firmware for hardware components of the server node. This can include the drive controller, the drives, a non-volatile random access memory (NVRAM) cache card, network interface cards, etc.

CheckHardware State. Further at the operation 260, the system validates all the hardware on the machine and ensures the hardware is in the proper configuration for the forthcoming operating system install. Such validation may include, for example, checking items such as, number, type and speed of the CPU; number, type and speed of memory dual in-line memory module (DIMMs); number, type and size of all the hard drives in the system; number, type and speed of the network adapters; firmware of all hardware components; etc.

TestHardware State. Further at the operation 260, this state provides for general stress/soak testing of hardware in the system. For example, the system may perform the stress/soak test against the hard drives (SSDs, NVRAM, SATADIMMs) in the system. Such testing looks for any performance anomalies as well as any input/output (I/O) errors.

DriveErase State. At an operation 265, in the DriveErase State, the system performs an ATA_SECURITY_ERASE operation to erase data on the solid state drives (SSDs). If the installation is an upgrade, then this state may be skipped entirely since an upgrade would erase all the customer data from the node. The ATA_SECURITY_ERASE command, in a new installation (not an upgrade) can perform a full erase cycle on the SSDs. Such a full erase cycle is helpful for a new installation where erasing the SSDs allows for a performance test or for more memory for a production customer to use. In an alternative embodiment, such as in testing, a block discard (blkdiscard) may be used. This effectively logically erases the drives without physically writing zeroes to the cells.

Backup State. During the backup state the system uses a mksquashfs command to backup the entire current (or old) root filesystem of the prior running operating system at an operation 270. With pivot_root access to the old filesystem is still available at /mnt/oldroot. The mksquashfs command to backup the old root filesystem has several advantageous attributes. The mksquashfs is massively parallelizable and utilizes all processing cores on the system to speed up the time to create the squashfs image. The mksquashfs command is extremely compressible. An entire backup image can be around 1 gigabyte (GB). The mksquashfs command can be directly mounted and have files natively accessed without having to unpack the files. Further, Linux can directly boot to a squashfs image and mount the backed up old root file system readonly. At an operation 275, with the backup image created, the system uses the kexec_load command to change the kernel parameters loaded into kexec memory as well as what the boot loader will use, so that the system will boot directly to the squashfs image. This is also advantageous for the rollback mechanism (error handler function) and is discussed further below.

Partition State. During this state, partitioning of the drives in a server node can be adjusted as needed. For example, if a larger partition is needed to support a particular part of a root filesystem or boot loader. During an iRTFI, the system may not add or delete any partitions as a fixed partition layout may already exist on server nodes. However, the system may create new (empty) file systems onto the existing partitions to ensure a fresh installation. However, in some cases the system may delete unused partitions or collapse multiple partitions into a single larger partition to meet demands of an operating system to be installed and/or adjust to pre-existing partitions already existing on a server node. The system may also be able to change filesystem types in this state.

Image State. During the Image state and at an operation 280, the system unpacks the payload contained within the filesystem.squashfs (installation image) which contains the new operating system including the new root filesystem to be installed onto the node. In other words, in the Image state, the node installs the new operating system onto the node by unpacking the payload of the installation image. The system can mount the root drive being installed to (e.g. /dev/sda2) at a particular directory (e.g. /mnt/chroot) and then the system can extract a compressed file of data into that directory. In other words, the root drive is mounted at a directory for the installation of the operating system and the new root files system is extracted from the installation image and into the directory. Advantageously, this install image can be a fully self-contained install image of an operating system (e.g., Element OS) and contains all binaries, configuration files, and all other content that should be installed onto a node. Additionally, the system can copy the filesystem.squashfs (installation image) that is currently being used to do the installation (and contains the compressed file that is being unpacked) into the chroot the system has just unpacked. This copied squashfs image can be used later to do an instantaneous ResetNode back to factory install without needing an external ISO or image. That is, even after an upgrade/downgrade/new install/etc., the system can be reset back to the operating system it previously had with this functionality.

Configure State. During the configuration state the system performs any configurations for the install image. Such configurations may include information that is not or cannot be placed directly into the install compressed file. For example, some information may not be in the compressed file because it is only available during install time itself. Such information may be, for example, hardware configuration (/etc/hardware/config.json), file system partition table (/etc/fstab), hostname (/etc/hostname), default networking (/etc/network/network.json), default cluster configuration (/etc/cluster.json), various settings for low memory virtual nodes, udev rules, fibre channel customization, configure boot loader, install modules generate SSL keys, etc.

Stop State. iRTFI has now successfully completed the main part of installation. In an operation 285, the system saves off all its logfiles and optionally uploads them to a requested external log server URL. In this way, RTFI's and iRTFI's can be logged and archived no matter how many times a server node has been up or down graded. The system will next use kexec_load to configure grub and kexec to boot to the newly installed OS on the root drive (e.g. /dev/sda2) with an additional kernel parameter (e.g., init=irtfi/bin/rtfi_postinst. In other words, in an operation 285, the system stores into the kexec memory a new kernel using the kexec_load command. Advantageously, this additional kernel, when it is booting up, instead of starting up normally by calling /sbin/init will instead call a custom post install script discussed below in the next state. In an operation 290 of FIG. 2B, the system boots to the operating system with the new kernel over the current running kernel using the kexec_exec command.

PostInstall State. After the system calls the kexec command into the new kernel the system launches the /rtfi/bin/rtfi_postinst script and enters the PostInstall state. During this state, the system can take the backup file created in the Backup state and mount it (readonly) at an operation 295. In other words, mount the backup of the old root file system and copy any files to be preserved from the old root file system. The system can then copy all files which need to be preserved across an iRTFI. During this state the system can also create a special ondisk file /rtfi/conf/pending_active_node.key that the product uses to indicate that a successful iRTFI has been completed. This can be used in an auto RTFI pending node feature, which can indicate to a user or other computing device the status of an RTFI on a node (e.g., (i)RTFI pending, (i)RTFI complete). The system can also bump an ondisk generation file (/rtfi/generation). This file can be accessed via an API and holds a monotonically increasing number to keep track of how many times a server node has been RTFI'd.

FinishSuccess State serves to indicate a successful iRTFI for automation and remote installation processes.

If an installation encounters an error, different failure paths are possible in order to maintain transactional consistency in the event of a failed iRTFI. Different possible failure paths are described below in the context of iRTFI. A transactionally consistent operation means in this context that the operation is a single transaction which will either succeed or fail and that the end result will either be the original data or the new data. In context of iRTFI, the system ensures that if iRTFI succeeds the new installation will exist on the server node with no traces of the old installation. Conversely, if it fails, the original, identical installation will exist on the server node with no traces of the new installation. In other words, if iRTFI fails, a rollback to the prior install occurs such that the operating system is exactly as it was before an iRTFI was started. In order to effect this, in one implementation the install code is written in bash with an internal bashutils framework that uses an ERR trap to call a custom die function for any error encountered in the system. The ERR trap is invoked by bash if any command returns a nonzero return code. When the trap gets called and the die function is invoked, iRTFI calls kexec_exec to execute the kernel and the custom kernel parameters that have been previously loaded into memory by the iRTFI process. In particular, the system uses a custom init script when kexec starts the new kernel (e.g. rtfi_rollback), and this script will essentially take a backup image and restore it to the root filesystem and then kexec back into that restored backup image to return the system to its state prior to the start iRTFI. Below are various failure paths that are possible. Additional failure paths than those explicitly disclosed herein are possible.

Failure during Prepare State. Here, an error is encountered very early in iRTFI during the Prepare phase/state. For example, the system may fail in fetching the remote installation image to use for the install (e.g. an invalid URL was provided for the image such that it could not be fetched). Before this error, an error handler function has already been set up. Here, the system may run a rtfi_inplace script which sources bashutils/efuncs.sh. This sets up a default error handler to ensure that the die command is called if any error is encountered. The system, as part of the Prepare State described above, calls a function (efetch) to fetch the remote image to install. If this fails, the system will return a 1 (which is an error since it is nonzero), which will automatically cause die to get called. Furthermore, there is a special check in die which recognizes that the system is in the Prepare State and exits with failure. Since the system has not done anything yet, there is nothing to rollback from or undo.

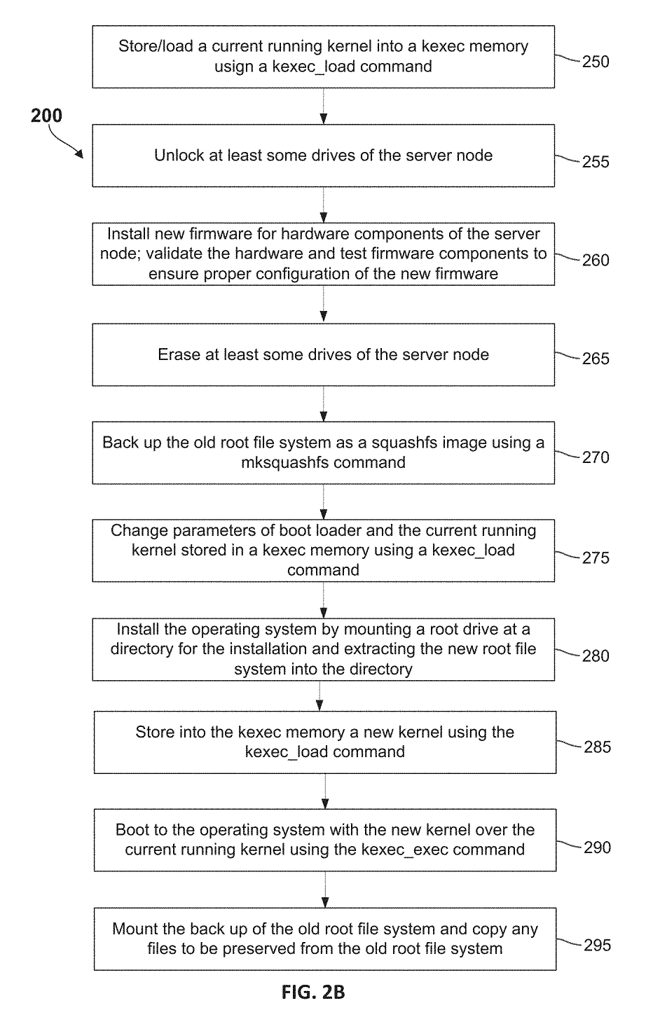

Failure during PreparePivotRoot. FIG. 3 shows a flow diagram 300 of a failure scenario prior to backup in accordance with an illustrative implementation. In alternative embodiments, fewer, additional, and/or different steps may be performed. Also, the use of a flow diagram is not meant to be limiting with respect to the order of steps performed. Further, the system may implement multiple instances of any of the methods disclosed herein, and may implement such methods in parallel. Similar to the previous example, the default error handling is already setup. Unlike the prior example of failure during a Prepare State, the system has started changing how the server node is operating. Specifically, the system has stopped all the running Upstart and SYSV init daemons and started moving some mounts around. In other words, in the PreparePivotRoot state, the system may have already started freeing up the root drive by stopping certain operations, moving pseudo filesystems from the root drive to a temporary file storage as described above with respect to the PreparePivotRoot state, and initializing processes to run an operating system for the server node from the temporary file storage. If the system encounters any errors during this state, the die command is invoked similar to the other failures disclosed herein. Indeed, at an operation 305, the system calls the error handler function in response to an error detected prior to backup of the old root file system. However, the system cannot exit as in the first example and leave the server node in an unreachable aberrant state. A new kernel has not been loaded yet at this stage in the iRTFI. As a result, the system can use kexec for rapid reboots so that this reboot takes a short amount of time (e.g., about 10 seconds). In other words, at an operation 310, the system invokes a kexec_exec command in response to the error to restart the current running kernel associated with the old root file system because no new kernel has been loaded into the kexec memory yet, and the old root file system is still intact. A new kernel is not loaded into kexec before this state because the inplace portion of RTFI is kept as minimalist as possible. Instead, the system has already had kexec_load called with respect to the original OS wo the system can call kexec_exec to quickly reboot the original kernel and OS and bypass a full reboot. At this point, the script is running in the old version of the software rather than the new version of the software. As such, bugs may be hard to fix so it is better to have a minimal amount of software at this point in the iRTFI process.

Failure after Start State but before Backup State. An error could occur for this failure path during Start State, DriveUnlock State, UpgradeFirmware State, CheckHardware State, TestHardware State and DriveErase State. Recall that the Start State calls kexec_load to load the current kernel against the current root drive into memory, such that if an error handler function calls a die command (invoking kexec_exec) the system can reboot using the currently running kernel. In other words, if there is an error during any of these states, the die command is called, and the system invokes kexec_exec to execute the new kernel that was previously loaded into the kexec memory in the Start State as discussed above. However, unlike the prior example of a failure during PreparePivotRoot, the system will have already called the kexec_load command to load the new kernel into kexec memory once the Start State has begun. However, nothing installed onto the old root filesystem has been altered in any way. Accordingly, there is still nothing to rollback from. As such, a simple kexec will return the server node to the state before iRTFI was initiated. In other words, even though the processes on the node have been stopped, the system can call kexec_exec to bypass a full reboot and do a quick reboot with kexec_exec into the new kernel because the new kernel operating with the new install image/file system has already been loaded into memory with the kexec_load command during the Start State.

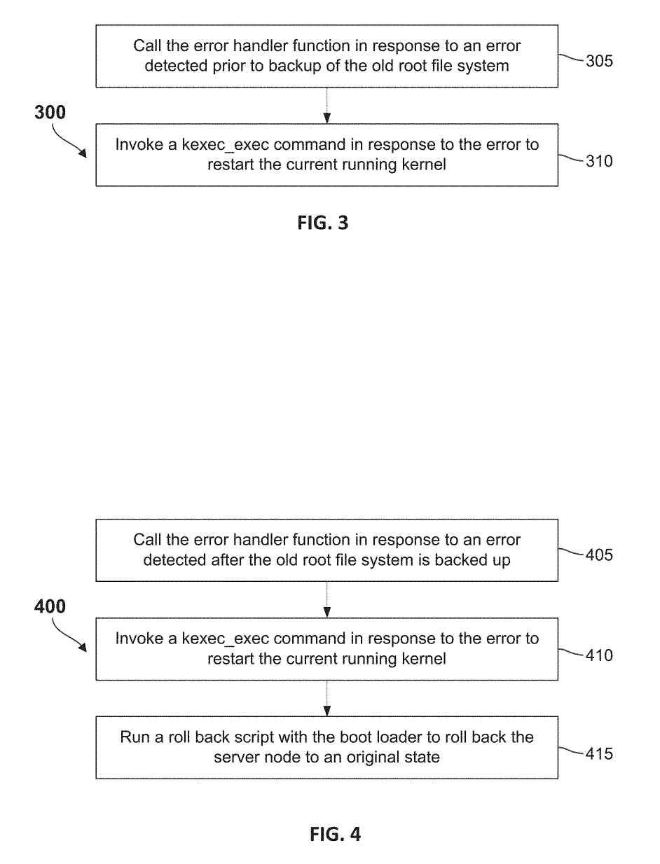

Failure after Backup State but before Stop State. FIG. 4 shows a flow diagram 400 of a failure scenario after backup in accordance with an illustrative implementation. In alternative embodiments, fewer, additional, and/or different steps may be performed. Also, the use of a flow diagram is not meant to be limiting with respect to the order of steps performed. Further, the system may implement multiple instances of any of the methods disclosed herein, and may implement such methods in parallel. During the Backup state, the system backs up the entire existing installation (old root file system) into a squashfs image residing on the /var/log partition (e.g. /dev/sda3). The system then sets the boot loader and kexec command (by loading into the kexec memory a new kernel) to boot directly to that squashfs image along with a very important extra kernel parameter init=irtfi/bin/rtfi_rollback. So, similar to the other errors, the die command gets invoked, and the system calls kexec_exec against the kexec settings set during the Backup State. In other words, at an operation 410, the system will invoke a kexec_exec command in response to the error to restart the current running kernel. This causes the kernel to instantly restart and instead of trying to call the normal init (/sbin/init), it instead invokes a custom rtfi_rollback script. This script does the opposite of the Backup State. It wipes out the other two partitions (/dev/sda1 and /dev/sda2) and creates new empty filesystems on them. Then it mounts those two drives into a directory, and extracts the backup image to that directory. This effectively restores what was originally installed on the server node back the way it originally was. In other words, as in an operation 415, the system runs a roll back script with the boot loader to roll back the server node to an original state. Once that is done the system sets the boot loader to boot back to /dev/sda2 and then executes a normal init (/sbin/init). The system has now successfully rolled back from the install failure.

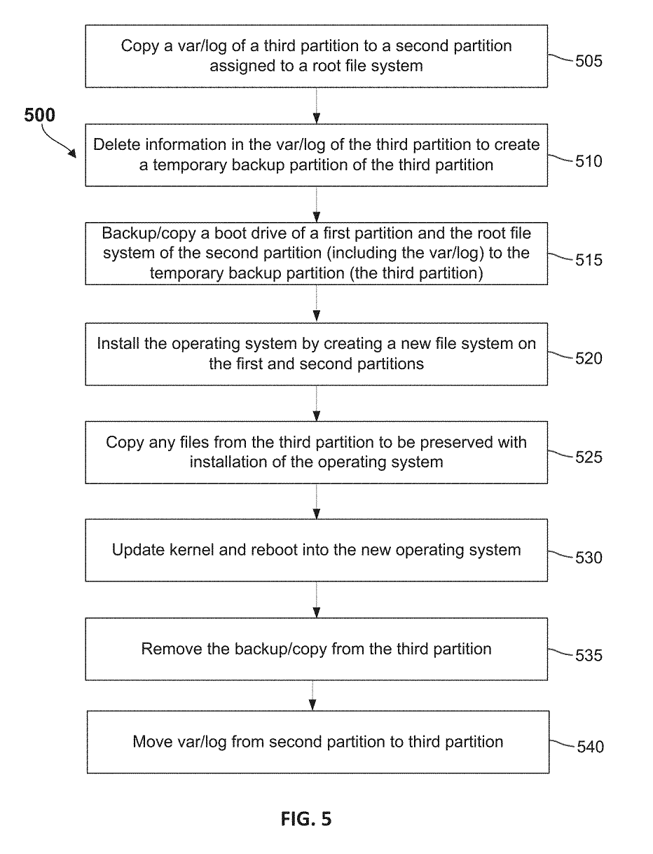

In alternative embodiments, the steps for performing an iRTFI may vary. For example, in one embodiment, the system may repurpose the /var/log partition (e.g. /dev/sda3) as a temporary backup partition. FIG. 5 shows a flow diagram 500 of an alternate embodiment of inplace return to factory install (iRTFI) in accordance with an illustrative implementation. In alternative embodiments, fewer, additional, and/or different steps may be performed. Also, the use of a flow diagram is not meant to be limiting with respect to the order of steps performed. Further, the system may implement multiple instances of any of the methods disclosed herein, and may implement such methods in parallel.

Specifically, during a Backup State, all the contents from the /var/log drive (e.g. /dev/sda3) (third partition) are copied into the root filesystem drive (e.g. /dev/sda2) (second partition). In other words, the system, at an operation 505, copies the /var/log of a third partition to a second partition assigned to a root file system. The system can would modify /etc/fstab so that the /var/log partition was not listed in the root filesystem drive. In other words, at an operation 510, the system deletes information in the /var/log of the third partition to create a temporary backup partition (made up of the third partition). The system would then proceed to wipe the contents of the former /var/log drive (e.g. /dev/sda3) and subsequently copy the boot drive (e.g. /dev/sda1) (first partition) and the root filesystem (e.g. /dev/sda2) over to this temporary backup partition (e.g. /dev/sda3). In other words, at an operation 515, the system backs up/copies a boot drive of a first partition and the root filesystem of the second partition (including the moved /var/log) to the temporary backup partition (the third partition). In an operation 525, the system copies any files from the third partition (original boot drive, filesystem, /var/log) that are to be preserved with installation of the operating system (e.g., in the case of an upgrade). Once that copy to the temporary backup partition is done, the system would then setup kexec and grub to boot to that partition and execute a rollback on failure via init=htfi/bin/rtfi_rollback kernel parameter. In other words, the system at an operation 530 updates the kernel and reboots into the new operating system. In an operation 535, the system removes the backup/copy from the third partition. In an operation 540, the system moves the /var/log from the second partition back to the third partition. Upon entering a failure state, when rollback was initiated, the system would perform the opposite of these steps to take the data residing on /dev/sda3 and put it back onto /dev/sda1 and /dev/sda2. The system would then wipe /dev/sda3 and then move /var/log from /dev/sda2 back into /dev/sda3.

Further embodiments and applications are contemplated by the systems and methods disclosed herein. For example, the iRTFI methods and systems may be utilized in a variety of applications. If a cluster server, such as the cluster server 101 of FIG. 1 discussed above, gets a new server node, the server node may communicate with other existing server nodes already in the cluster server 101 in order to determine which operating system (boot drive, root filesystem, etc.) the new server node should be using. The existing server node(s) could communicate a link or other information about the operating system in use, and the new server node could use that information to fetch the installation image as disclosed herein. With the installation image, the iRTFI could be initiated and the new server node could quickly and easily get software/operating system/etc. that matches the other existing nodes in the server cluster 101. Advantageously, the systems and methods disclosed herein for iRTFI can be executed on a single server node. Prior methods of updating operating systems often use two or more drives to update an operating system. The methods and systems disclosed herein preserve time, resources, lower down time, and reduce chances of error in up or down grading server nodes.

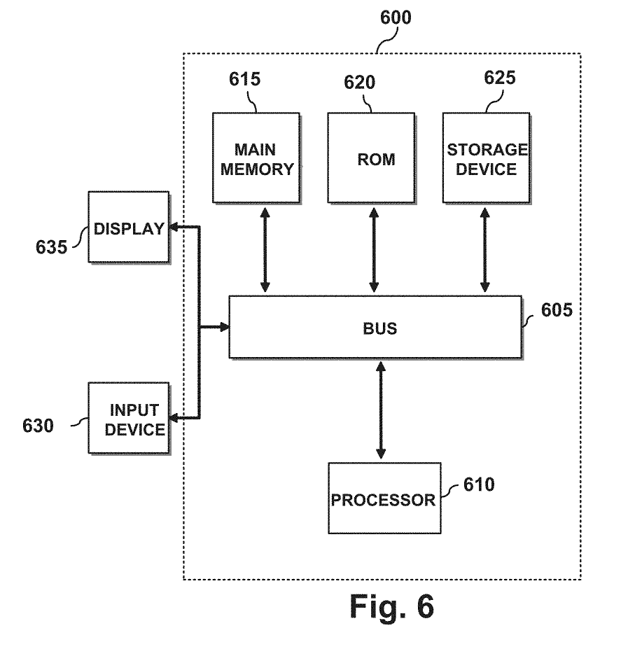

FIG. 6 is a block diagram of a computer system 600 in accordance with an illustrative implementation. The computing system 600 includes a bus 605 or other communication component for communicating information and a processor 610 or processing circuit coupled to the bus 605 for processing information. The computing system 600 can also include one or more processors 610 or processing circuits coupled to the bus for processing information. The computing system 600 also includes main memory 615, such as a random access memory (RAM) or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a read only memory (ROM) 620 or other static storage device coupled to the bus 605 for storing static information and instructions for the processor 610. A storage device 625, such as a solid state device, magnetic disk or optical disk, is coupled to the bus 605 for persistently storing information and instructions.

The computing system 600 may be coupled via the bus 605 to a display 635, such as a liquid crystal display, or active matrix display, for displaying information to a user. An input device 630, such as a keyboard including alphanumeric and other keys, may be coupled to the bus 605 for communicating information and command selections to the processor 610. In another implementation, the input device 630 has a touch screen display 635. The input device 630 can include a cursor control, such as a mouse, a trackball, or cursor direction keys, for communicating direction information and command selections to the processor 610 and for controlling cursor movement on the display 635.

According to various implementations, the processes described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. In alternative implementations, hard-wired circuitry may be used in place of or in combination with software instructions to effect illustrative implementations. Thus, implementations are not limited to any specific combination of hardware circuitry and software.

Although an example computing system has been described in FIG. 6, implementations described in this specification can be implemented in other types of digital electronic circuitry, or in computer software, firmware, or hardware, including the structures disclosed in this specification and their structural equivalents, or in combinations of one or more of them.

Implementations described in this specification can be implemented in digital electronic circuitry, or in computer software, firmware, or hardware, including the structures disclosed in this specification and their structural equivalents, or in combinations of one or more of them. The implementations described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings and tables in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

One or more flow diagrams have been used herein. The use of flow diagrams is not meant to be limiting with respect to the order of operations performed. The herein-described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A server node comprising one or more processors configured to:
fetch an installation image of an operating system comprising a new root file system for the server node, wherein the server node initially is running an original operating system;
mount the installation image into a temporary file storage;
change a root file system of the server node to the new root file system and maintain the root file system as an old root file system;
install new firmware for hardware components of the server node;
install the operating system, wherein installation of the operating system comprises:
mount a root drive at a directory for the installation; and
extract the new root file system into the directory; and
boot to the operating system with a new kernel replacing the original operating system.

2. The server node of claim 1, wherein the root file system is changed with a pivot_root command.

3. The server node of claim 1, wherein the installation image is mounted into the temporary file storage with a read-write on top of the installation image.

4. The server node of claim 1, wherein the one or processors are further configured to run an installation script from the installation image that installs the new firmware, installs the operating system, and boots to the operating system with the new kernel.

5. The server node of claim 1, wherein the current running kernel is stored into a kexec memory using a kexec_load command after the installation image is mounted into the temporary file storage.

6. The server node of claim 5, wherein the one or processors are further configured to:
call an error handler function in response to an error detected prior to a backup of the old root file system; and
restart the current running kernel in response to the error.

7. The server node of claim 1, wherein the one or processors are further configured to unlock at least some drives of the server node after the change of the root file system.

8. The server node of claim 1, wherein the installation of the new firmware for the hardware components comprises an upgrade or a downgrade of firmware for the hardware components.

9. The server node of claim 1, wherein the one or processors are further configured to, after the new firmware is installed, validate the hardware components and stress test at least some of the firmware components of the server node.

10. The server node of claim 1, wherein the one or processors are further configured to erase at least some drives of the server node after the new firmware is installed.

11. A method of installing an operating system on a server node comprising:
fetching an installation image of an operating system comprising a new root file system for the server node, wherein the server node initially is running an original operating system;
mounting the installation image into a temporary file storage;
changing a root file system of the server node to the new root file system and maintaining the root file system as an old root file system;
installing new firmware for hardware components of the server node;
installing the operating system, wherein installation of the operating system comprises:
mounting a root drive at a directory for the installation, and
extracting the new root file system into the directory; and
booting to the operating system with a new kernel replacing the original operating system.

12. The method of claim 11, further comprising backing up the old root file system after the new firmware is installed.

13. The method of claim 12, wherein the old root file system is backed up as a squashfs image using a mksquashfs command.

14. The method of claim 13, further comprising changing parameters of a boot loader and the current running kernel stored in a kexec memory using a kexec_load command.

15. The method of claim 14, further comprising:
call an error handler function in response to an error detected after the old root file system is backed up;
invoke a kexec_exec command in response to the error to restart the current running kernel, wherein the boot loader runs a roll back script to roll back the server node to an original state of the server node similar to the server node before the installation image was fetched.

16. The method of claim 12, further comprising, after the old root file system is backed up:
mounting the backed up old root file system; and
copying files from the backed up old root file system that are to be preserved over an upgrade or downgrade of the operating system for the server node.

17. The method of claim 11, further comprising storing, before booting to the operating system, into a kexec memory the new kernel using a kexec_load command, wherein the booting to the operating system uses a kexec_exec command.

18. A non-transitory computer-readable medium having instructions stored thereon, that when executed by a computing device cause the computing device to perform operations comprising:
fetching an installation image of an operating system comprising a new root file system for a server node, wherein the server node initially is running an original operating system;
mounting the installation image into a temporary file storage;
changing a root file system of the server node to the new root file system and maintaining the root file system as an old root file system;
installing new firmware for hardware components of the server node;
installing the operating system, wherein installation of the operating system comprises:
mounting a root drive at a directory for the installation, and
extracting the new root file system into the directory; and
booting to the operating system with a new kernel replacing the original operating system.

19. The non-transitory computer readable medium of claim 18, wherein the instructions further cause the computing device to perform operations comprising, setting up, prior to fetching the installation image, an error handling function such that if an error is encountered the server node can be rolled back into an original state.

20. The non-transitory computer readable medium of claim 18, wherein the instructions further cause the computing device to perform operations comprising creating, prior to fetching the installation image, an in-memory filesystem that is used to hold an entire chroot image of the installation image of the operating system.
